(19) United States
(12) Patent Application Publication
(10) Pub. No.: US 2013/0303089 A1
(43) Pub. Date: Nov. 14, 2013

(54) Uplink and/or Downlink Testing of Wireless Devices in a Reverberation Chamber

(71) Applicant: APPLE INC., Cupertino, CA (US)

(72) Inventors: Xiaowen Wang, Cupertino, CA (US); Weiping Dou, San Jose, CA (US); Warren Lee, Santa Clara, CA (US); Zhaojun Cheng, Burnaby (CA); Syed Aon Mujtaba, Santa Clara, CA (US)

(73) Assignee: APPLE INC., Cupertino, CA (US)

(21) Appl. No.: 13/651,823

(22) Filed: Oct. 15, 2012

Related U.S. Application Data
(60) Provisional application No. 61/646,010, filed on May 11, 2012.

(51) Int. Cl. H04W 24/00

(52) U.S. Cl. 455/67.12

(57) ABSTRACT

A system and method for wireless device testing. The system includes a reverberation chamber (RC) and a downlink channel emulator. A wireless device is placed within the RC. Probe antennas are positioned within the RC. The downlink (DL) channel emulator couples to the probe antennas. The DL channel emulator is configured to: (a) receive downlink stimulus signals; and (b) generate downlink intermediate signals based on the downlink stimulus signals in order to emulate desired downlink channel characteristics. The probe antennas are configured to respectively transmit the downlink intermediate signals into the RC for reception by the wireless device. The system may also include an uplink channel emulator, which receives uplink transmit signals from the RC, and generates uplink terminal signals based on the uplink transmit signals in order to emulate desired uplink channel characteristics. The uplink transmit signals may be used to evaluated the performance of the wireless device.

### PRIORITY CLAIM

The present application claims benefit of priority to U.S. Provisional Application No. 61/646,010, filed on May 11, 2012, entitled “Simultaneous Uplink and Downlink MIMO Testing in a Reverberation Chamber”, invented by Xiaowen Wang, Weiping Dou, Warren Lee, Zhaojun Cheng, and Syed Aon Mujtaba, which is hereby incorporated by reference in its entirety as though fully and completely set forth herein.

### FIELD

The present application relates generally to device testing, and more particularly, to systems and methods for testing wireless devices.

### DESCRIPTION OF THE RELATED ART

In recent years, a multitude of electronic devices that are capable of performing wireless communication have been created and used. One difficulty in designing such devices is properly testing the wireless communication mechanism of the device, both in pristine and varying environments. To that end, devices have been tested using anechoic chambers, such as shown in FIG. 1.

More specifically, in FIG. 1, a device 100 may be tested. As shown, a base station (BS) 150 is in communication with a probe antenna 110 and a link antenna 120. The probe antenna 110, the link antenna 120 and the device 100 are within the anechoic chamber. Thus, in the prior art example shown in FIG. 1, there is only one direct radio path between the probe antenna 110 and the device 100. Such testing does not allow for environments which cause the signal to vary over time, such as fading environments.

### SUMMARY

Various systems and methods for the testing of wireless devices are herein disclosed.

In one set of embodiments, a system for wireless device testing may include a reverberation chamber (RC), a plurality of probe antennas, and a downlink (DL) channel emulator. The reverberation chamber is configured to house a wireless device. The probe antennas are positioned within the reverberation chamber, e.g., at or near an interior wall of the reverberation chamber. The DL channel emulator may be coupled to the probe antennas. The DL channel emulator may be configured to receive downlink stimulus signals, and to generate downlink intermediate signals based on the downlink stimulus signals in order to emulate desired downlink channel characteristics. The probe antennas may be configured to respectively transmit the downlink intermediate signals into the reverberation chamber for reception by the wireless device.

Various uplink mechanisms are contemplated. For example, a link antenna may be positioned within the reverberation chamber near the wireless device, and used to receive an uplink transmit signal transmitted by the wireless device. The uplink transmit signal may be provided directly from the link antenna to a base station (or access point) via a cable. Alternatively, the uplink transmit signal may be supplied to an uplink channel emulator, which generates uplink terminal signals based on the uplink transmit signal. The base station (or access point) may operate on the uplink terminal signals.

In one implementation, the uplink channel emulator receives uplink transmit signals from the probe antennas, not from a link antenna. The uplink channel emulator generates uplink terminal signals based on the uplink transmit signals in order to emulate desired uplink channel characteristics.

In one set of embodiments, a system for testing wireless devices may include a first reverberation chamber, a second reverberation chamber and a first channel emulator. A first set of probe antennas are located in the first reverberation chamber. A second set of probe antennas are located in the second reverberation chamber. The first reverberation chamber is configured to house a first wireless device. The second reverberation chamber is configured to house a second wireless device.

The probe antennas of the first set are configured to respectively receive first input signals from the first reverberation chamber in response to transmission by the first wireless device. The first channel emulator is coupled to the first set of probe antennas and the second set of probe antennas. The first channel emulator is configured to generate first output signals based on the first input signals, and transmit the first output signals into the second reverberation chamber using respectively the second set of probe antennas.

In some implementations, the system may also include a second channel emulator coupled to the first set of probe antennas and the second set of probe antennas. The probe antennas of the second set are configured to respectively receive second input signals from the second reverberation chamber in response to transmission by the second wireless device. The second channel emulator is configured generate second output signals based on the second input signals, and transmit the second output signals into the first reverberation chamber using respectively the first probe antennas.

In one set of embodiments, a system and method may involve testing wireless devices in a reverberation chamber (RC). A wireless device may be placed in the RC. Downlink stimulus signals may be provided to a downlink (DL) channel emulator. The DL channel emulator may generate downlink intermediate signals based on the downlink stimulus signals in order to emulate desired downlink channel characteristics. Probe antennas are used to respectively transmit the downlink intermediate signals into the RC. The wireless device receives downlink terminal signals in response to the transmission of the downlink intermediate signals. Furthermore, the wireless device may transmit uplink response signals from within the RC. The probe antennas respectively receive intermediate uplink signals in response to the transmission of the uplink response signals. The reception of the uplink intermediate signals and the transmission of the downlink intermediate signals may be performed at the same time (e.g., using duplexers). Accordingly, uplink and downlink transmission of the wireless device may be concurrently tested. For example, the transmitter and receiver mechanisms of the wireless device may be concurrently tested.

Alternatively, the reception of the uplink intermediate signals and the transmission of the downlink intermediate signals may be performed in an alternating fashion, i.e., one after the other.

An uplink (UL) channel emulator may generate uplink output signals based on the uplink intermediate signals (received from the probe antennas) in order to emulate desired uplink channel characteristics. Test results may be generated based on the uplink output signals. The method may be repeated for a plurality of different sets of uplink channel characteristics and/or a plurality of different sets of downlink channel characteristics.

### BRIEF DESCRIPTION OF THE DRAWINGS

A better understanding of the present subject matter can be obtained when the following detailed description is considered in conjunction with the following drawings.

FIG. 1 illustrates a prior art system for testing wireless devices in an anechoic chamber.

FIG. 2 illustrates an example of a device that may be subjected to testing according to the methods variously described herein.

FIG. 3 illustrates an example of a system for testing wireless devices such as device 100, where the system includes a downlink channel emulator 160 and a reverberation chamber RC.

FIG. 4 illustrates another example of a system for testing wireless devices, where the system includes a downlink channel emulator 160, an uplink channel emulator 170 and a reverberation chamber RC.

FIG. 5 illustrates an example of a downlink calibration setup for a testing system.

FIG. 6 illustrates an example of a testing system involving a MIMO downlink and SIMO uplink. (MIMO is an acronym for “multiple-input multiple-output. SIMO is an acronym for single-input single-output.)

FIG. 7 illustrates an example of a testing system involving MIMO downlink and MIMO

FIG. 8 illustrates an example of a system for peer-to-peer testing of wireless devices.

FIG. 9 illustrates one implementation of a method for testing wireless devices using a reverberation chamber.

FIG. 10 illustrates another implementation of a method for testing wireless devices using a reverberation chamber.

FIG. 11 illustrates one implementation of a method for testing wireless devices in a peer-to-peer fashion.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF EMBODIMENTS

### Acronyms

### AP: Access Point

### BS: Base Station

### CE: Channel Emulator

### CRC: Cyclic Redundancy Check

### DL: Downlink

### EVDO: Evolution-Data Optimized or Evolution-Data Only

### FDD: Frequency Division Duplexing

### HSPA: High Speed Packet Access

### LTE: Long Term Evolution

### MIMO: Multiple-Input Multiple-Output

### RC: Reverberation Chamber

### SIMO: Single-Input Multiple-Output

### SISO: Single-Input Single-Output

### TDD: Time Division Duplexing

### UL: Uplink

### UMTS: Universal Mobile Telecommunications System

### Terminology

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of memory as well or combinations thereof. In addition, the memory medium may be located in a first device in which the programs are executed, or may be located in a second different device which connects to the first device over a network, such as the Internet. In the latter instance, the second device may provide program instructions to the first device for execution. The term “memory medium” may include two or more memory media which may reside in different locations, e.g., in different devices that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), personal communication device, smart phone, a media player, a personal digital assistant, television system, grid computing system, or other device or combinations of devices. In general, the term “computer system” can be broadly defined to encompass any device (or combination of devices) having at least one processor that executes instructions from a memory medium.

Portable Device—any of various types of computer systems which are mobile or portable, including portable gaming devices (e.g., Nintendo DS™, PlayStation Portable™, Gameboy Advance™, iPhone™), laptops, PDAs, mobile phones, handheld devices, portable Internet devices, media players, data storage devices, etc. In general, the term “portable device” can be broadly defined to encompass any electronic, computing, and/or telecommunications device (or combination of devices) which is easily transported by a user.

Wireless Device—any of various devices which are capable of wireless communication with other devices. Wireless device is a superset of portable devices with wireless communication capabilities (e.g., a wireless device may be portable or stationary). Wireless devices include cell phones, wireless access points (e.g., wireless routers) and other devices capable of wireless communication with other devices. For example, a wireless device may be configured to utilize one or more wireless protocols, e.g., 802.11x, Bluetooth, WiMax, CDMA, GSM, UMTS, LTE, etc., in order to communicate with the other devices wirelessly.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed).

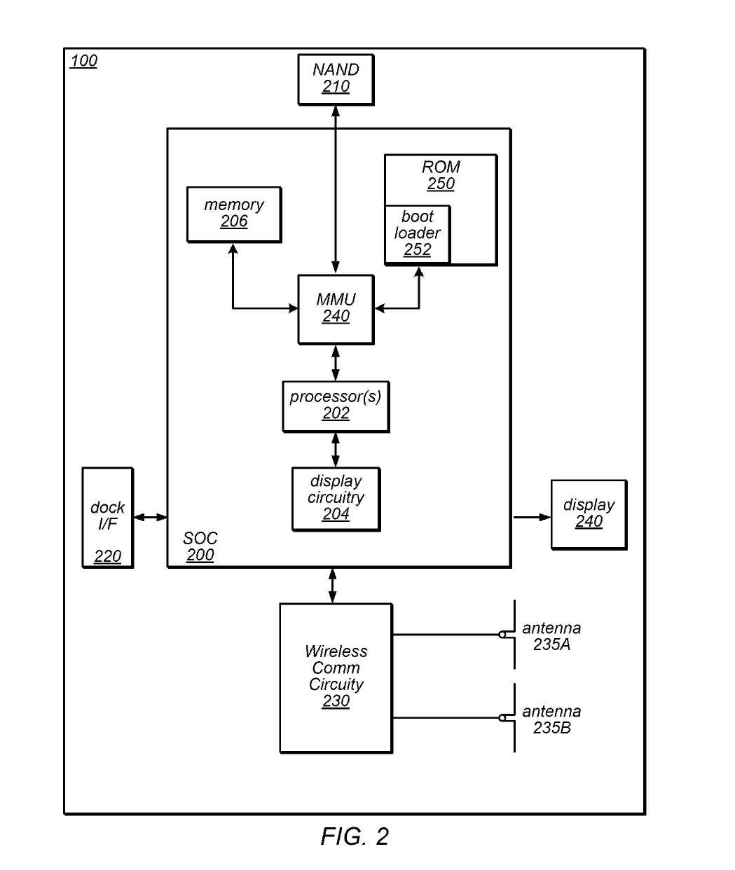

FIG. 2—Example Wireless Device

FIG. 2 illustrates an example of a wireless device 100 that may be tested using any of the various methods described herein. The wireless device 100 may be any of various devices. For example, the wireless device 100 may be a portable or mobile device such as a mobile phone, PDA, a portable media player, an audio/video player, etc. The device 100 may also be any of various other devices, e.g., devices such as computer systems, laptops, netbooks, tablet computers, etc. The wireless device 100 may be configured to communicate with other devices (e.g., other wireless devices, wireless peripherals, cell towers, access points, base stations, radio transceivers, etc.) according to one or more wireless communication standards.

The device 100 may include a display (or an interface for coupling to a external display), which may be operable to display graphics provided by an application executing on the device 100. The application may be any of various applications, such as, for example, games, internet browsing applications, email applications, phone applications, video chat applications, video player applications, productivity applications, 3D graphics applications, etc. The application may be stored in a memory medium of the device 100. As described below, the device 100 may include a processor (e.g., a CPU) and display circuitry (e.g., including a GPU) which may collectively execute these applications.

In more detail, FIG. 2 illustrates an example block diagram of the device 100. As shown, the device 100 may include a system on chip (SOC) 200, which may include portions for various purposes, including processor 202, display circuitry 204, and memory medium 206. As also shown, the SOC 200 may be coupled to various other circuits of the device 100. For example, the device 100 may include various types of memory (e.g., including NAND 210), a dock interface 220 (e.g., for coupling to an external computer system), the display 240, and wireless communication circuitry 230 (e.g., for communication according to one or more standards such as GSM, UMTS, LTE, CDMA2000, Bluetooth, WiFi, GNSS, GPS, etc.). The wireless communication circuitry may use one or more antennas 235 to perform the wireless communication. FIG. 2 illustrates the case where two antennas (i.e., antennas 235A and 235B) are used. The wireless device 100 may be configured to perform MIMO (Multiple-Input Multiple-Output) communications with a base station or access point or another wireless device.

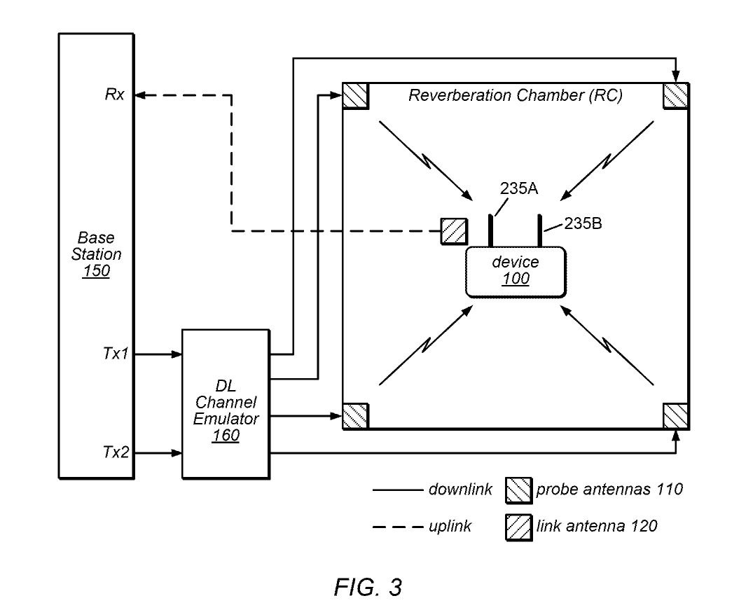

FIG. 3: Example Environment for Downlink Testing

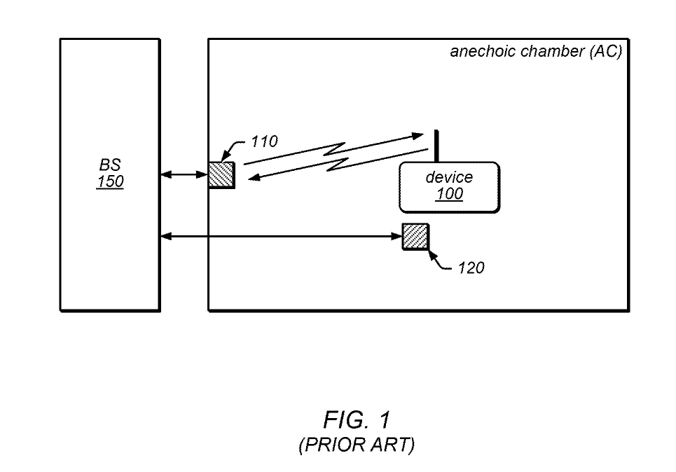

FIG. 3 illustrates one embodiment of a testing environment that may be used to test a wireless device such as the wireless device 100 discussed above. As shown in FIG. 3, the device 100 is included within a reverberation chamber (RC) as opposed to the anechoic chamber (AC) of FIG. 1. A link antenna 120 may be positioned at (or near) the device 100. Additionally, a plurality of probe antennas 110 (in this case, four probe antennas) are positioned within the reverberation chamber, preferably at (or near) the interior wall of the reverberation chamber. For example, the reverberation may be a 3D rectangular parallelepiped, and the probe antennas may be positioned at the corners of the parallelepiped (as viewed from above).

The base station (BS) 150 generates downlink stimulus signal, e.g., based on a stream of information bits, and outputs the downlink stimulus signals (also referred to herein as “transmission signals”) at its transmit ports Tx1 and Tx2. Each transmit port provides a corresponding one of the downlink stimulus signals. While the base station shown in FIG. 3 has two transmit ports, more generally, the base station may include any number of transmit ports. For example, in other embodiments, the number of transmit ports may be, respectively, three, four, five, six, seven and eight.

The downlink (DL) channel emulator 160 may emulate desired downlink channel characteristics such as the power and delay profiles specified by any of various communication standards, or power and delay profiles customized by field playback. (“Field playback” means recording channel measurements, such as path loss, in the field for later usage in testing. “Customizing by field playback” means applying the field play back, such as path loss to the channel emulator to create the radio environment closely mimicking the field.) In some embodiments, the desired channel characteristics may also include Doppler shifts.

Channel emulators are well known in the field of wireless device testing. The DL channel emulator 160 may be realized by any of a variety of existing channel emulators. The DL channel emulator 160 generates intermediate downlink signals based on the downlink stimulus signals and in accordance with the desired downlink channel characteristics. The DL channel emulator 160 is programmable, i.e., the downlink channel parameters that determine the downlink intermediate signals from the downlink stimulus signals are programmable, e.g., by an external test controller.

The probe antennas 110 respectively transmit the intermediate downlink signals into the reverberation chamber. The wireless device 100 receives downlink terminal signals in response to the transmission of the intermediate downlink signals. The wireless device may demodulate and decode the downlink terminal signals to obtain estimated information bits, i.e., estimates of the original information bits (that were used to generate the downlink stimulus signals). The estimated information bits may be used to generate one or more uplink signals. For example, the uplink signals may include acknowledgements indicating whether or not respective downlink transmissions were successfully received and decoded by the wireless device 1010. A downlink packet may include error detection information such as CRC bits to allow the wireless device to determine when the decoding of the downlink packet has been successful. The wireless device may also use the downlink signals to measure the quality of radio environment, and report the measured quality back to the base station in the uplink signals.

The wireless device 100 may transmit the one or more uplink signals through the antennas 235 (e.g., antennas 235A and 235B) or a selected one of the antennas 235. While FIG. 3 shows the wireless device as having two antennas, any number of antennas may be used.

The link antenna 120 may receive the one or more uplink signals transmitted by the wireless device 100, and provide the one or more uplink signals to a receive port Rx of the base station 150. The link antenna may be located in the near field of the antennas 235. Thus, the link antenna acts like a conducted port, and there is little or no fading on the uplink channel.

The base station 150 may demodulate the one or more uplink signals in order to recover estimates of the information bits that were transmitted by the wireless device. The base station or a test controller may evaluate the performance of the downlink processing of the wireless device by counting the acknowledgements sent by the wireless device. Furthermore, the base station may determine if any information bits need to be retransmitted based on the acknowledgement. The base station may further determine how the information bits (new transmission or retransmission) should be transmitted, e.g., in which MIMO mode or modulation, based on the radio quality report it receives from the wireless device via the uplink signals.

The fading environment (that is experienced by the signals transmitted from the probe antennas) in the RC chamber can be calibrated to a flat fading channel. The overall composite channel from the base station to the device antennas 235 then can be viewed as a multipath fading channel with each path represented by a complex Gaussian random variable due to the superposition of the probe antennas at the wireless device.

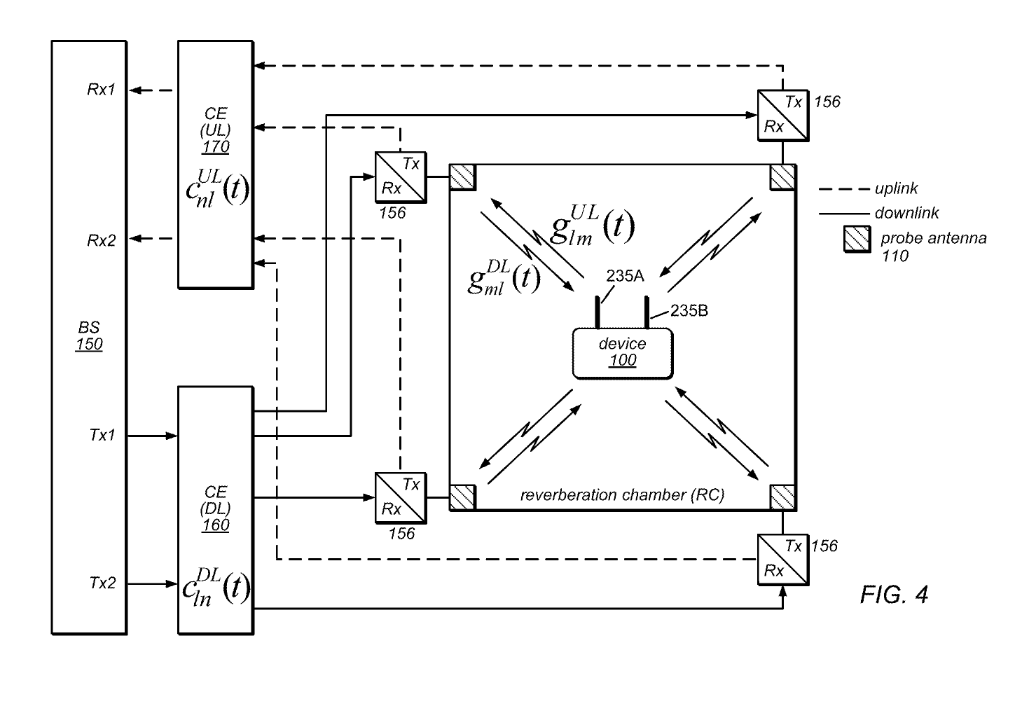

FIG. 4: Example System for Simultaneous Uplink and Downlink Testing

FIG. 4 illustrates a testing system which may be used to test the wireless device 100 and which enables simultaneous uplink and downlink MIMO testing. As shown, the base station 150 includes two transmit ports (Tx1 and Tx2) and two receive ports (Rx1 and Rx2). However, more generally, the base station may include any number of receive ports greater than one, and any number of transmit ports greater than one. The base station 150 generates downlink stimulus signal based on a stream of downlink information bits, and outputs at each transmit port a corresponding one of the downlink stimulus signals. Furthermore, the base station 150 receives at each receive port a corresponding uplink terminal signal.

The downlink channel emulator 160 may generate downlink intermediate signals from the downlink stimulus signal as described above. The impulse response cₗₙ^{DL}(t) characterizes the downlink relationship between the n^{th} downlink stimulus signal and the l^{th} downlink intermediate signal, or, in other words, between the n^{th} transmit port of the base station and the l^{th} probe antenna. The impulse responses {cₗₙ^{DL}(t)} Of are programmable.

The probe antennas 110 respectively transmit the downlink intermediate signals into the reverberation chamber. The antennas 235 of the wireless device 100 receive respective downlink terminal signals in response to the transmission of the downlink intermediate signals. The impulse response gₘₗ^{DL}(t) characterizes the downlink relationship between the l^{th} downlink intermediate signal and the m^{th} downlink terminal signal, or in other words, between the l^{th} probe antenna and the m^{th} device antenna.

The wireless device 100 demodulates the downlink terminal signals to obtain estimated downlink information bits, i.e., estimates of the downlink information bits that were transmitted by the base station.

The wireless device 100 generates uplink signals {uₘ(t)} and transmits the uplink signals through the respective device antennas 235. In a downlink test of the wireless device, the uplink signals may be generated based at least partially on the estimated downlink information bits. In an uplink test of the wireless device, the uplink signals may be generated based on a known sequence of uplink information bits, i.e., a sequence that is known to the test controller (not shown).

The probe antennas 110 respectively receive uplink intermediate signals {vₗ(t)} in response to the transmission of the uplink signals {uₘ(t)}. The impulse response gₗₘ^{UL}(t) characterizes the uplink relationship between the uplink signal uₘ(t) and the intermediate uplink signal vₗ(t), i.e., between the m^{th} device antenna and the l^{th} probe antenna.

The probe antennas 110 may be simultaneously used to transmit the downlink intermediate signals and receive the uplink intermediate signals. To facilitate the simultaneous transmission and reception, each probe antenna may be coupled to a corresponding duplexer 156. Thus, the test system of FIG. 4 may be used to perform uplink testing and downlink testing at the same time.

The uplink channel emulator 170 receives the uplink intermediate signals {vₗ(t)} respectively from the probe antennas 110, and generates uplink terminal signals based on the uplink intermediate signals. The uplink channel emulator emulates characteristics of the uplink channel, e.g., characteristics such as power and delay profile of a set of channel paths. The characteristics may also include the Doppler shift of the respective paths. The impulse response cₙₗ^{UL}(t) characterizes the uplink relationship between the uplink intermediate signal vₗ(t) and the n^{th} uplink terminal signal, i.e., between the l^{th} probe antenna and the n^{th} receive port of the base station 150.

The base station 150 receives the uplink terminal signals at the respective receive ports. (Two receive ports Rx1 and Rx2 are shown. However, any number of receive ports may be supported.) The base station may demodulate the uplink terminal signals in order to produce estimates of the information bits transmitted by the wireless device. The base station or test controller (not shown) may evaluate the downlink performance of the wireless device, e.g., by counting acknowledgements as described above in connection with FIG. 3. Furthermore, the base station or the test controller may evaluate the uplink performance of the wireless device by comparing the estimated information bits to a known set of information bits that are transmitted by the wireless device as part of an uplink test. Alternatively, the base station or test controller may evaluate the uplink performance of the wireless device by examining the number of CRC failures in the data received from the wireless device. (The wireless device may include CRC bits or other error detection information in each uplink transmission to enable the base station to determine when its decoding has been successful.)

The reverberation chamber (RC) in FIGS. 3 and 4 may be used to create a fading environment for testing, e.g., a Rayleigh fading environment. This environment may be used to simultaneously perform uplink and downlink tests, e.g., multiple-input multiple-output (MIMO) tests.

### Derivation for Downlink Transmission

A derivation corresponding to one embodiment of the downlink channel is provided below. The impulse response from the n^{th} transmit port of the base station 150 to the m^{th} device antenna of the device 100 may be described by the expression:

$${h}_{mn}^{DL} ( t ) = {\sum }_{l = 0}^{3} \int {g}_{m l}^{DL} ( t - τ ) {c}_{l n}^{DL} ( τ ) d τ ,$$

where m=0, 1, . . . , M_{d}−1, and n=0, 1, . . . , N_{bt}−1, where M_{d} is the number of antennas of the wireless device 100, wherein N_{bt} is the number of transmit ports of the base station 150. FIG. 4 corresponds to the case M_{d}=N_{bt}=2.

The signal cₗₙ^{DL}(t) is the impulse response from the n^{th} transmit port of the base station to the l^{th} probe antenna. The signal gₘₗ^{DL}(t) is the impulse response from the l^{th} probe antenna to the m^{th} device antenna.

The impulse response cₗₙ^{DL}(t) may have the form:

$${c}_{l n}^{DL} ( t ) = {\sum }_{k = 0}^{{N}_{l n}} {c}_{l n}^{k} δ ( t - {t}_{l n}^{k} ) ,$$

where k=0, 1, . . . , Nₗₙ−1, where Nₗₙ is a positive integer, where {cₗₙ^{k}} are complex Gaussian random variables. The set of real constants {tₗₙ^{k}} is referred to herein as the delay profile. The set of constants {E[∥cₗₙ^{k}∥²]} is referred to herein as the power profile. The power profile {E[∥cₗₙ^{k}∥²]}, the delay profile {tₗₙ^{k}} and the value Nₗₙ are programmable.
The above expression for cₗₙ^{DL}(t) is a simplified version that ignores the time axis and considers only the delay domain. A more complete expression is:

$${c}_{l n}^{DL} ( T , t ) = {\sum }_{k = 0}^{{N}_{l n}} {c}_{l n}^{k} ( T ) δ ( t - {t}_{l n}^{k} ) ,$$

where cₗₙ^{k}(T) is a complex Gaussian random variable that depends on the dimension T, where T corresponds to the amount of Doppler shift.

If

gₘₗ^{DL}(t)=gₘₗ^{DL}δ(t−t₀),

where t₀ is the time delay of the path from the l^{th} probe antenna to the m^{th} device antenna, where gₘₗ^{DL} is a complex Gaussian random variable with zero mean and variance of 1, then

$${h}_{mn}^{DL} ( t ) = {\sum }_{l = 0}^{3} {g}_{m l}^{DL} {c}_{l n}^{DL} ( t - {t}_{0} ) .$$

In some embodiments, the randomness in the complex variable gₘₗ^{DL} is due to placing the wireless device on a turn table in the reverberation chamber RC. During the test, the turn table may turn at a rate determined by the desired amount of Doppler shift. Similar to the random variables cₗₙ^{k}, one may model the random variables gₘₗ^{DL} as being dependent on the dimension T, i.e., gₘₗ^{DL}=gₘₗ^{DL}(T). However, the amount of variation in the random variables gₘₗ^{DL} may typically be less than (e.g., much less than) the amount of variation in the random variables cₗₙ^{k}(T).

In some circumstances, the impulse response hₘₙ^{DL}(t) can be approximated by a complex Gaussian random variable with the same power and delay profile as

cₗₙ^{DL}(t) if E[∥gₘₗ^{DL}∥²]=1,

where ∥gₘₗ∥ represents the norm of gₘₗ^{DL}.

Note that cₗₙ^{DL}(t) is a linear combination of complex Gaussian random variables, and thus, is itself a complex Gaussian random variable. To guarantee the power delay profile approximation, the reverberation chamber's fading needs to be a flat fading, i.e., there is only one path with delay t₀ in gₘₗ^{DL}(t) and the reverberation chamber (RC) needs to have unit power. With RC calibration, it is possible to attain both conditions.

### Derivation for Uplink Transmission

The impulse response from the m^{th} antenna of the device 100 to the n^{th} antenna (receive port) of the base station 150 may be described by the expression:

$${h}_{n m}^{UL} ( t ) = {\sum }_{l = 0}^{3} \int {c}_{nl}^{UL} ( t - τ ) {g}_{l m}^{UL} ( τ ) d τ ,$$

where m=0, 1, . . . , M_{d}−1, and n=0, 1, . . . , N_{br}−1, where M_{d} is the number of antennas of the wireless device 100, where N_{br} is the number of receive ports at the base station 150.

The impulse response cₙₗ^{UL} may have the form:

$${c}_{nl}^{UL} ( t ) = {\sum }_{k = 0}^{{N}_{nl}} {c}_{nl}^{k} δ ( t - {t}_{nl}^{k} ) ,$$

where k=0, 1, . . . , Nₙₗ, where Nₙₗ is a positive integer, where {cₙₗ^{k}} are complex Gaussian random variables, where {tₙₗ^{k}} are real constants. The power profile {E∥cₙₗ^{k}∥²}, the delay profile {tₙₗ^{k}} and Nₙₗ are programmable.

If gₗₘ^{UL}(t)=gₗₘ^{UL}δ(t−t₀), where gₗₘ^{UL} is a complex Gaussian random variable with zero mean and variance of 1, then

$${h}_{n m}^{UL} ( t ) = {\sum }_{l = 0}^{3} {c}_{n l}^{UL} ( t - {t}_{0} ) {g}_{l m}^{UL} .$$

In some circumstances, hₙₘ^{UL}(t) can be approximated by a complex Gaussian random variable with the same power and delay profile as

cₙₗ^{UL}(t) if E[∥gₗₘ^{UL}∥²]=1.

### Setup of Channel Emulators

The following procedure may be used to setup the DL channel emulator 160.

1) Set the power profile and delay profile of the DL channel emulator according to the desired channel type. Power profile and delay profile are basic parameters used to characterize a fading channel. For the typical channel types such as PA, VA, PB in LTE or Case 1/Case 2 in UMTS, the power and delay profiles are well defined in specifications and already pre-programmed in many commercial channel emulators. Moreover, current channel emulators typically provide the user with the ability to program customized power profile and delay profile.

2) Set the transmit correlation matrix as:

$${R}_{Tx} = [ \begin{matrix}1 & α \\ α & 1\end{matrix} ] ,$$

where α is the correlation between the transmit (Tx) antenna ports of the base station 150.

3) Set the receive (Rx) correlation matrix as:

$${R}_{Rx} = [ \begin{matrix}1 & 0 & 0 & 0 \\ 0 & 1 & 0 & 0 \\ 0 & 0 & 1 & 0 \\ 0 & 0 & 0 & 1\end{matrix} ] .$$

The entry R_{Rx}(i,j) of the matrix R_{Rx} represents the correlation of the output ports i and j of the channel emulator. These correlations are used to ensure that the inputs to the reverberation chamber RC are independent, i.e., E[gₘₗ_{₁}^{DL}gₘₗ_{₂}^{DL}*]=0 if l₁≠l₂. This property of independence is crucial to obtain the approximation discussed above. The reasoning is as follows. hₘₙ^{DL}(t) is a combination of four random variables (so called double Rayleigh), or more generally, N_{PA} random variables, where N_{PA} is the number of RC probe antennas. The theory of large numbers states that a summation of n independent and identically distributed (i.i.d.) random variables approaches a Gaussian random variable as n approaches infinity. Therefore, to obtain the desired Gaussian random variable in the limit, we need the random variables in the summation to be independent. This is why the receive correlation matrix has the above-stated form.

The following procedure may be used to setup the UL channel emulator 170.

1) Set the power and delay profile of the UL channel emulator according to the desired channel type.

2) Set the transmit correlation matrix as

$${R}_{Tx} = [ \begin{matrix}1 & 0 & 0 & 0 \\ 0 & 1 & 0 & 0 \\ 0 & 0 & 1 & 0 \\ 0 & 0 & 0 & 1\end{matrix} ]$$

The entry R_{Tx}(i,j) of the matrix R_{Tx} represents the correlation of the input ports of the channel emulator.

3) Set the receive correlation matrix as

$${R}_{Rx} = [ \begin{matrix}1 & β \\ β & 1\end{matrix} ] ,$$

where β is the correlation between the receive antenna ports of the base station 150.

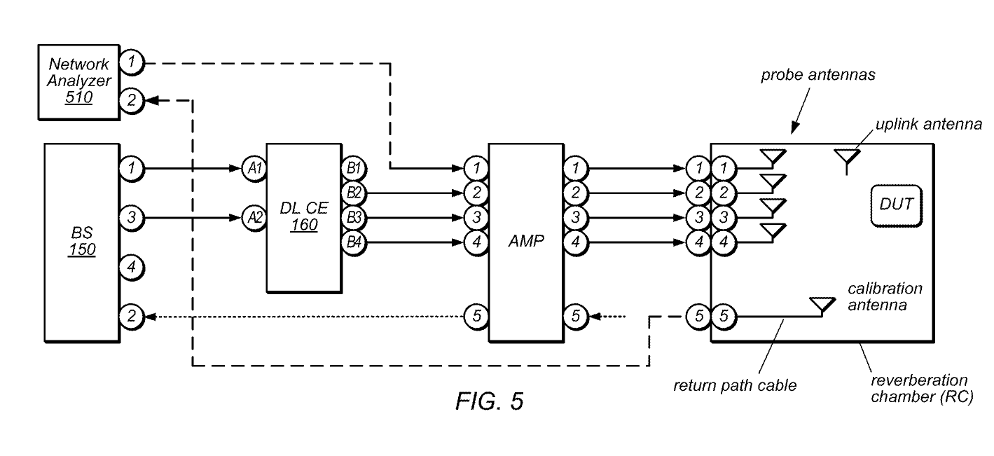

FIG. 5—Downlink and Uplink Calibration

Calibration may allow the reverberation chamber (RC) to provide a flat and uniform fading environment.

FIG. 5 illustrates an example setup for downlink calibration. In this setup, the average path loss for each DL path may be calibrated using a network analyzer 510. The dashed lines coupling to the network analyzer correspond to network analyzer cables that have been normalized. The solid lines flowing from the base station 150 (or base station simulator) to the downlink channel emulator 160, from the downlink channel emulator to the amplifier AMP, and from the amplifier AMP to the reverberation channel RC are system RF cables for the DL paths. The dotted line to Amp input #5 and the dotted line from Amp output #5 to the base station input #3 are system RF cables for the UL path. The line from the calibration antenna to port #5 of the RC is a return path cable that has been normalized.

The uplink (UL) may be calibrated using the same setup as the DL calibration. For time division duplexing (TDD) systems including TD-LTE and WiFi, the reciprocity of the radio channel may ensure that the UL and DL can use the same calibration. For frequency division duplexing (FDD) systems, UL and DL may be able to share the same calibration for those bands with Tx-Rx separation ˜500 MHz or less, which may apply to all commercial systems, including LTE, HSPA, and EVDO.

The calibration may be performed using the following procedure.

A. The forward path losses from the conducted ports (the transmit ports) of the base station to the conducted ports of the probe antennas may be calibrated. (The term “conducted port” means the signal feed point.) Depending on the capability of the equipment, each lag of the forward path, e.g., port 1 of the base station to port A1 of the channel emulator or port A1 of the channel emulator to port B1 of the channel emulator in FIG. 5, can be calibrated individually or combined. “Calibration” of the forward path losses means measuring the forward path losses, and using the measurements to compensate the losses of the cable and equipment.

B. The return path loss from the uplink antenna to the network analyzer 510 may be calibrated. “Calibration” of the return path loss means measuring the return path loss, and using the measured return path loss to compensate the loss from the wireless device to the base station BS.

C. The reverberation chamber (RC) may be calibrated as follows.

1) Place the testing device and initial loading material in the RC. “Loading material” means the absorber placed inside the RC to adjust the power delay profile of the RC.

2) Send a known signal through each probe antenna.

3) Use a calibration antenna with known efficiency to measure the average path loss of radiated path in the RC. Both the forward link and return link path losses are known from the previous steps. Therefore, the impulse response of the entire path from the base station BS to the wireless device can be calculated.

### Test Cases for Three Applications

The following sections provide test cases for three applications as follows.

1) SIMO (e.g., LTE SIMO). In this case, the transmitter has one antenna, and the receiver has two or more antennas. (SIMO is an acronym for “single-input multiple-output”. The terms “input” and “output” occurring here are interpreted from the point of view of the channel.) In uplink SIMO, the transmitter is the wireless device 100 and the receiver is the base station 150.

2) MIMO (e.g., LTE MIMO or WiFi MIMO). In this case, the transmitter has two or more antennas, and the receiver has two or more antennas. In downlink MIMO, the transmitter is the base station, and the receiver is the wireless device. In uplink MIMO, the transmitter is the wireless device, and the receiver is the base station.

3) Peer to Peer. This case is for communication between peer devices such as two wireless devices (e.g., audio/visual devices).

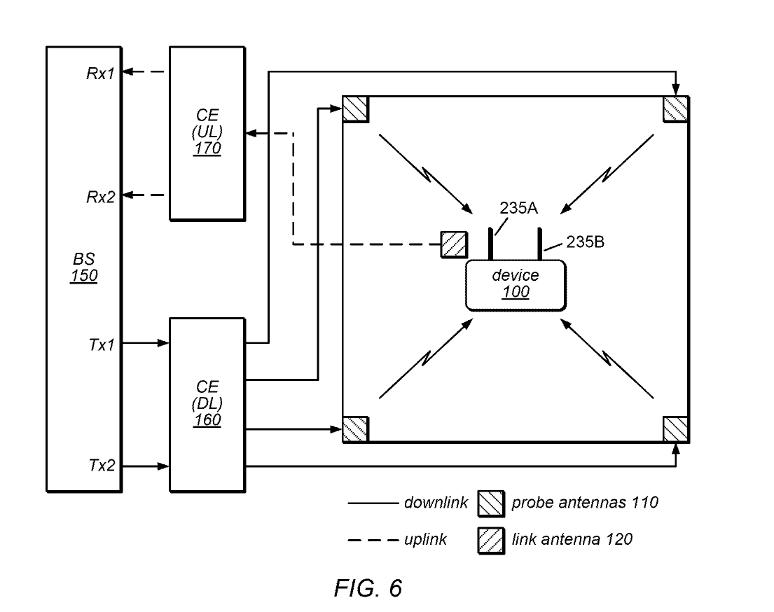

FIG. 6 illustrates a testing environment for MIMO downlink (DL) and SIMO uplink (UL). The MIMO DL may be implemented using the downlink channel emulator 160, as variously described above. The SIMO UL may be implemented by using uplink channel emulator 170, which can add uplink fading and adjust uplink path loss based on downlink path loss setting. In one implementation, the uplink channel emulator is set up with 1 input and 2 outputs. (More than two outputs may be supported in alternative implementations.) The link antenna 120 may act as a conducted port.

The wireless device 100 generates an uplink signal u(t), and transmits the uplink signal. In an uplink test, the uplink signal u(t) may be generated based on known uplink information, i.e., information known to the test controller (not shown). The wireless device may include error detection information such as CRC bits in the uplink transmission so that base station can determine when successful decoding has occurred. In a downlink test, the uplink signal may be generated based at least partially on estimated downlink information bits. For example, the uplink signal may include acknowledgements and radio quality reports as described above. Thus, the uplink may be used to provide feedback to the base station about the performance of the wireless device's downlink processing.

The link antenna 120 receives the uplink signal u(t). The uplink signal u(t) may be provided from the link antenna 120 to the uplink channel emulator 170 by a cable. The uplink channel emulator generates two uplink terminal signals based on the uplink signal u(t). The two uplink terminal signals are provided respectively to the two receive ports of the base station 150.

The base station 150 may demodulate the uplink terminal signals to obtain estimated uplink information bits. The base station or a test controller may evaluate the downlink performance of the wireless device based on the estimated uplink information bits, e.g., by counting acknowledgements. The base station of test controller may evaluate the uplink performance of the wireless device by comparing the estimated uplink information bits to a known set of original information bits, or by counting CRC failures.

### Channel Emulator Setup for Testing Corresponding to FIG. 6

The downlink channel emulator may be setup using the following procedure.

1) Set the power and delay profile as desired.

2) Set the transmit (Tx) correlation matrix as:

$${R}_{Tx} = [ \begin{matrix}1 & α \\ α & 1\end{matrix} ] ,$$

where α is the correlation between transmit antenna ports at the base station 150.

3) Set the receiver (Rx) correlation matrix as:

$${R}_{Rx} = [ \begin{matrix}1 & 0 & 0 & 0 \\ 0 & 1 & 0 & 0 \\ 0 & 0 & 1 & 0 \\ 0 & 0 & 0 & 1\end{matrix} ] .$$

The uplink channel emulator may be setup using the following procedure.

1) Set the power and delay profile to as desired.

2) Set the receiver (Rx) correlation matrix as

$${R}_{Rx} = [ \begin{matrix}1 & β \\ β & 1\end{matrix} ] ,$$

where β is the correlation between receive antenna ports at the base station 150.

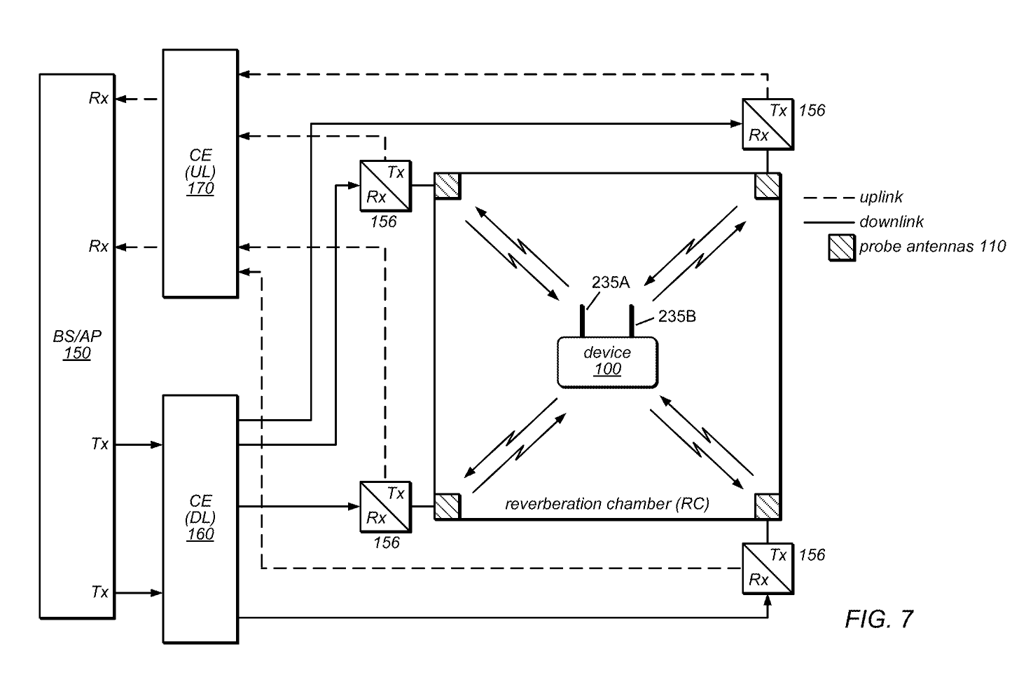

FIG. 7 illustrates a testing environment for MIMO DL, MIMO UL, or UL antenna selection, similar to FIG. 4 described above. In one embodiment, DL and UL signals may be transmitted at the same time. The probe antenna 110 may simultaneously transmit into the reverberation chamber (RC) and receive from the reverberation chamber. DL fading may be created by the RC and the DL channel emulator 160. UL fading may be created by the RC and the UL channel emulator 170. The DL channel emulator 160 and the UL channel emulator 170 may operate at the same time. Additionally, the uplink path loss may be adjusted based on the downlink path loss setting.

For the UL communication, the device 100 may either transmit through the two antennas 235 or may switch between the two antennas. In the latter case, the UL antenna selection may be based on DL measurements. Both DL measurements may be affected by the DL fading; and UL transmit performance may be affected by the UL fading.

DL meaurements refer to measurements of signal strength, such as RSSI/RSCP/EcIo in UMTS or RSSI/RSRP/SINR in LTE. Based on the difference of these measurments between two antennas, one can make a judgment of which antenna would be the better one to use for transmission, i.e. has better antenna efficiency in term of transmission.

In some embodiments, the wireless device has only one transmitter chain. (For example, in some embodiments, the addition of a second power amplifier may be deemed to be too costly and/or to increase power consumption too much.) Thus, the wireless device may make measurements as described above to determine which of the device antennas to use for transmission. In other embodiments, the wireless device has a plurality of transmitter chains.

### Setup of Channel Emulators for Test Corresponding to FIG. 7

The DL channel emulator may be setup as follows.

1) Set the power and delay profile as desired.

2) Set the transmit (Tx) correlation matrix as:

$${R}_{Tx} = [ \begin{matrix}1 & α \\ α & 1\end{matrix} ] ,$$

where α is the correlation between transmit antenna ports at the base station (or access point).

3) Set the receive (Rx) correlation matrix as:

$${R}_{Rx} = [ \begin{matrix}1 & 0 & 0 & 0 \\ 0 & 1 & 0 & 0 \\ 0 & 0 & 1 & 0 \\ 0 & 0 & 0 & 1\end{matrix} ] .$$

The UL channel emulator may be setup as follows.

1) Set the power and delay profile as desired.

2) Set the transmit (Tx) correlation matrix as:

$${R}_{Tx} = [ \begin{matrix}1 & 0 & 0 & 0 \\ 0 & 1 & 0 & 0 \\ 0 & 0 & 1 & 0 \\ 0 & 0 & 0 & 1\end{matrix} ] .$$

3) Set the receive (Rx) correlation matrix as:

$${R}_{Rx} = [ \begin{matrix}1 & β \\ β & 1\end{matrix} ] ,$$

where β is the correlation between receive antenna ports of the base station (or access point).

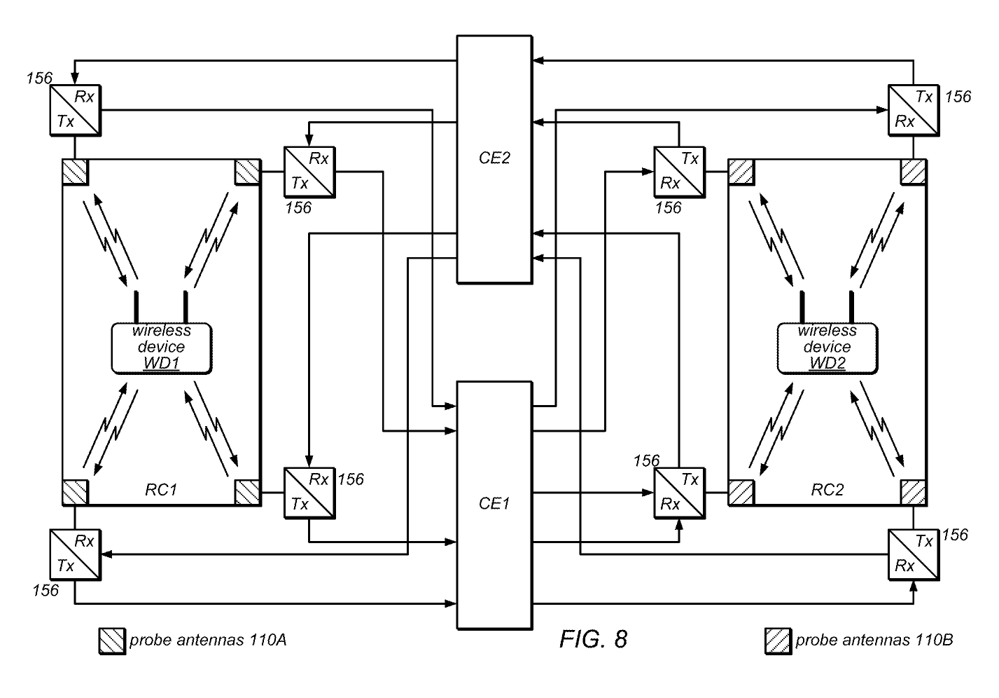

FIG. 8 illustrates an environment for testing wireless devices that are configured to communicate in a peer-to-peer fashion, e.g., for two WiFi devices or two Bluetooth devices. The wireless devices WD1 and WD2 may transmit and receive data in a peer-to-peer mode. Wireless device WD1 may be placed in a reverberation chamber RC1. Wireless device WD2 may be placed in a reverberation chamber RC2. The channel emulator CE1 may be used to create a fading environment for wireless device WD2. The channel emulator CE2 may be used to create a fading environment for wireless device WD1. The wireless devices may operate using MIMO, SISO, SIMO, selective diversity, or any combination thereof.

Each reverberation chamber includes a respective set of probe antennas. The reverberation chamber RC1 includes probe antennas 110A. The reverberation chamber RC2 includes the probe antennas 110B.

The probe antennas 110A receive signals from the reverberation chamber RC 1 in response to transmissions from the wireless device WD1. The received signals are provided to the channel emulator CE1, which generates output signals based on the received signals. The output signals are supplied respectively to probe antennas 110B. The probe antennas 110B respectively transmit the output signals into reverberation chamber 110B for reception by the wireless device WD2.

The probe antennas 110B receive signals from the reverberation chamber RC2 in response to transmissions from the wireless device WD2. The received signals are provided to the channel emulator CE2, which generates output signals based on the received signals. The output signals are supplied respectively to probe antennas 110A. The probe antennas 110A respectively transmit the output signals into reverberation chamber RC 1 for reception by the wireless device WD 1. The channel emulators CE 1 and CE2 may be programmable, e.g., described above in connection with channel emulator 160 or channel emulator 170. The channel emulators allow fading environments to be emulated.

### Setup of Channel Emulators for Testing According to FIG. 8

The channel emulator CE1 may be setup as follows.

1) Set the power and delay profile as desired.

2) Set both the Tx correlation matrix and the Rx correlation matrix as:

$${R}_{Tx} = {R}_{Rx} = [ \begin{matrix}1 & 0 & 0 & 0 \\ 0 & 1 & 0 & 0 \\ 0 & 0 & 1 & 0 \\ 0 & 0 & 0 & 1\end{matrix} ] .$$

The channel emulator CE2 may be setup as follows.

1) Set the power and delay profile as desired.

2) Set both the transmit (Tx) correlation matrix and the receive (Rx) correlation matrix to:

$${R}_{Tx} = {R}_{Rx} = [ \begin{matrix}1 & 0 & 0 & 0 \\ 0 & 1 & 0 & 0 \\ 0 & 0 & 1 & 0 \\ 0 & 0 & 0 & 1\end{matrix} ] .$$

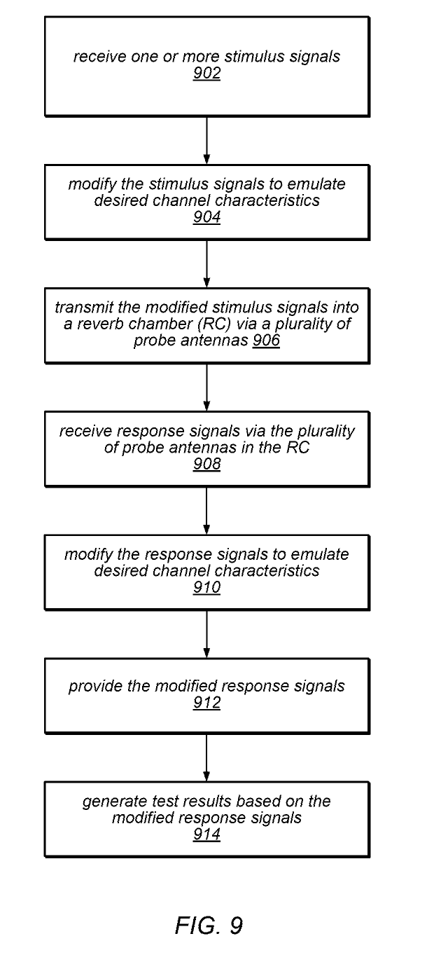

FIG. 9—Testing Wireless Device(s) Using a Reverberation Chamber

FIG. 9 illustrates one embodiment of a method for testing one or more wireless devices using a reverberation chamber. The method shown in FIG. 9 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 902, one or more stimulus signals may be received, e.g., from an access point or base station. These stimulus signals may be intended for use in testing a wireless device. The stimulus signals may be received by a channel emulator (CE), e.g., similar to that shown in FIG. 4.

In 904, the stimulus signals may be modified to emulate desired channel characteristics. For example, the stimulus signals may be modified to have desired power and/or delay profiles, e.g., as specified by different standards or customized through field data playback, e.g., standards such as 802.11, WiMAX, Bluetooth, LTE, UMTS, etc. Additionally, the stimulus signals may be modified to have desired Doppler shifts. The modification may be performed by a channel emulator, e.g., a downlink CE as variously described above.

In 906, the modified stimulus signals may be transmitted to the wireless device via a plurality of probe antennas within a reverberation chamber (RC). In some embodiments, the number of signals received (e.g., in 902) may be different from the number of probe antennas. For example, there may be two transmission lines or signals from the base station (BS), but there may be more (e.g., four) probe antennas. Accordingly, the modified signals may be provided respectively to the probe antennas. The probe antennas, in turn, may transmit the modified signals into the RC, for reception by the wireless device. The probe antennas may include or be associated with corresponding duplexers in order to transmit and receive signals to/from the RC simultaneously.

In 908, response signals may be received from the wireless device by the probe antennas within the RC. For example, the wireless device may respond to the stimulus signals of 902 and/or previous stimulus signals, or may generally transmit independent signals for reception by the probe antennas. In some embodiments, the modified stimulus signals and the response signals may be transmitted/received concurrently. In other embodiments, the signals may be provided in an alternating fashion (i.e., taking turns, one after the other), though perhaps at a short time scale. In either case, both uplink and downlink communication can be performed and/or tested for the wireless device at the same time. The response signals may be provided from the probe antennas to a second channel emulator (e.g., an uplink CE).

In 910, the response signals may be modified to emulate desired channel characteristics. For example, the response signals may be modified by the uplink CE to emulate the desired channel characteristics. These characteristics may be the same as or different from those in 904, as desired.

In 912, the modified response signals may be provided, e.g., back to the access point or base station. Similar to 906, the number of provided signals may be different than the number of received signals. For example, following the embodiment where there are four probe antennas, the number of signals may be reduced from four to two (e.g., where the BS has two reception signal lines or reception channels).

In 914, test results may be generated based on the modified response signals, e.g., as variously described above. For example, the response signals may be compared to expected response signals (e.g., expected response signals based on the stimulus signals and/or the desired channel characteristics used). For example, a difference between the received and expected response may be generated and analyzed to determine whether it is within desired specification ranges.

The method of FIG. 9 may be performed in an iterative fashion, e.g., for different communication standards or communication bands in order to determine overall test results for the wireless device. For example, a plurality of sets of channel characteristics may be used to verify that the wireless device adequately communicates in each of the fading environments created by the channel characteristics.

The testing method of FIG. 9 may be used to verify system designs (e.g., during the design phase for verifying a particular design) and/or to verify manufactured wireless devices (e.g., during manufacturing phase, to verify that there are no defects or anomalies for the particular device).

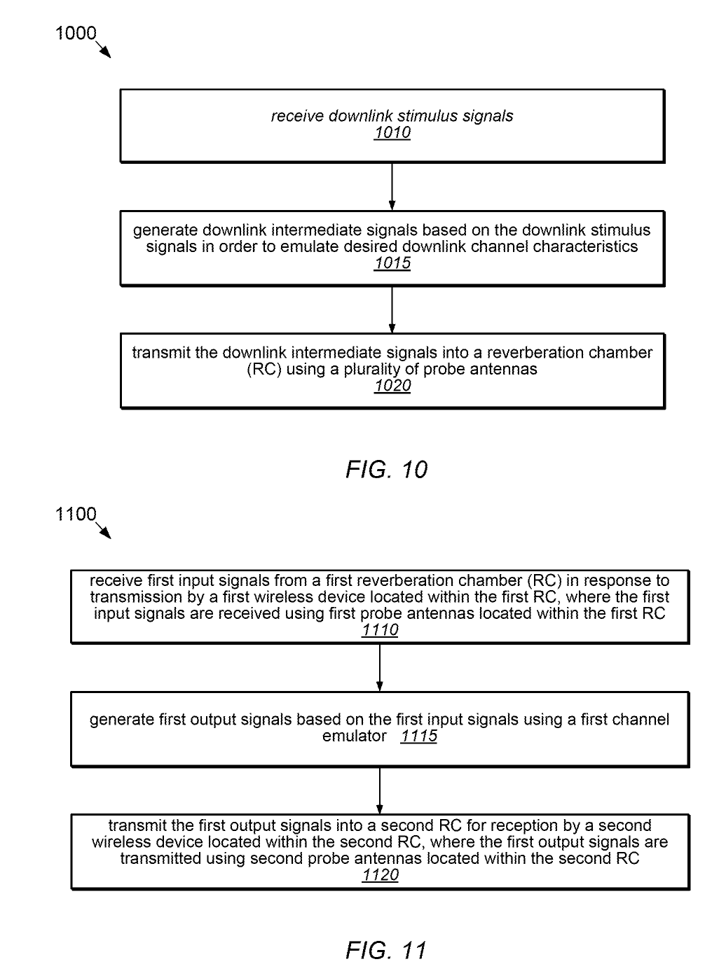

FIG. 10—Method for Testing a Wireless Device Using Reverb Chamber

In one set of embodiments, a method 1000 for testing a wireless device may include the operations shown in FIG. 10. The method 1000 may be performed using any of the system realizations described above. Furthermore, the method 1000 may include any subset of the features, elements and operations described above.

At 1010, downlink stimulus signals may be received, e.g., from transmit ports of a base station or an access point.

At 1015, downlink intermediate signals may be generated based on the downlink stimulus signals in order to emulate desired downlink channel characteristics. The downlink intermediate signals may be generated using a downlink channel emulator, e.g., as variously described above.

At 1020, the downlink intermediate signals may be transmitted into a reverberation chamber (RC) using a plurality of probe antennas. The wireless device is positioned within the reverberation chamber, e.g., as variously described above.

In some implementations, the method 1000 may also include: receiving uplink intermediate signals from the RC using the probe antennas, where the uplink intermediate signals are received in response to transmission of uplink transmit signals by the wireless device; and generating uplink output signals based on the uplink intermediate signals in order to emulate desired uplink channel characteristics, where the uplink output signal are generated by an uplink channel emulator. The action of transmitting the downlink intermediate signals and the action of receiving of the uplink intermediate signals are performed concurrently or at least partially concurrently. In other circumstances, the transmitting action and the receiving action may be performed alternately, i.e., one after the other.

In some implementations, the method 1000 may also include: (a) receiving an uplink signal transmitted by the wireless device, where the uplink signal is received using a link antenna positioned within the RC; and (b) providing the uplink signal from the link antenna to a receive port of a base station or access point using an electrical conductor (e.g., an RF cable).

In some implementations, the method 1000 may also include: receiving an uplink transmit signal transmitted by the wireless device, where the uplink transmit signal is received using a link antenna positioned within the RC; and generating uplink terminal signals based on the uplink transmit signal, where the uplink terminal signals are generated using an uplink channel emulator, e.g., as variously described above.

FIG. 11—Testing Method Using Two Reverberation Chambers and Channel Emulators

In one set of embodiments, a method 1100 for testing two wireless devices in a peer-to-peer fashion may include the operations shown in FIG. 11. The method 1100 may be performed using any of the system realizations described above in connection with FIG. 8. Furthermore, the method 1100 may include any subset of the features, elements and operations described above.

At 1110, first input signals are received from a first reverberation chamber (RC) in response to transmission by a first wireless device located within the first RC. The first input signals may be received using first probe antennas located within the first RC, e.g., as variously described above.

At 1115, first output signals are generated based on the first input signals using a first channel emulator, e.g., as variously described above.

At 1120, the first output signals are transmitted into a second RC for reception by a second wireless device located within the second RC. The first output signals may be transmitted into the second RC using second probe antennas located within the second RC, e.g., as variously described above.

In some implementations, the method 1100 may also include: (a) receiving second input signals from the second RC in response to transmission by the second wireless device, where the second input signals are received using the second probe antennas; (b) generating second output signals based on the second input signals using a second channel emulator, and (c) transmitting the second output signals into the first RC for reception by the first wireless device, where the second output signals are transmitted using the first probe antennas.

In some embodiments, the action of transmitting the first output signals and the action of transmitting the second output signals are performed concurrently, or at least partially concurrently. In other embodiments, the transmitting action and the receiving action may be performed alternately, i.e., one after the other.

The first output signals may be generated according to a specified set of impulse responses that relate the first output signals to the first input signals. Each of the impulse responses may have a programmable power profile and a programmable delay profile. Similarly, the second output signals may be generated according to a specified set of impulse responses that relate the second output signals to the second input signals, where each of the impulse responses has a programmable power profile and a programmable delay profile.

The various embodiments described above may allow for the testing of wireless devices under realistic environments, e.g., realistic OTA fading channel environments. (OTA is an acronym for “Over The Air”.) Prior solutions were either devoted to static environments (e.g., non-fading environments), which cannot faithfully predict MIMO performance in the field, or were typically much more costly and time consuming.

Numerous variations and modifications will become apparent to those skilled in the art once the above disclosure is fully appreciated. It is intended that the following claims be interpreted to embrace all such variations and modifications.

What is claimed is:

1. A system for wireless device testing, the system comprising:
a reverberation chamber (RC) configured to house a wireless device;
a plurality of probe antennas within the RC;
a downlink (DL) channel emulator coupled to the probe antennas, wherein the DL channel emulator is configured to:
receive downlink stimulus signals;
generate downlink intermediate signals based on the downlink stimulus signals in order to emulate desired downlink channel characteristics, wherein the probe antennas are configured to respectively transmit the downlink intermediate signals into the RC for reception by the wireless device.

2. The system of claim 1, further comprising:
an uplink (UL) channel emulator coupled to the plurality of probe antennas, wherein the probe antennas are configured to respectively receive uplink intermediate signals from the RC in response to transmission of uplink transmit signals by the wireless device, wherein the UL channel emulator is configured to:
generate uplink output signals based on the uplink intermediate signals in order to emulate desired uplink channel characteristics; and
provide the uplink output signals to respective outputs of the UL channel emulator.

3. The system of claim 2, wherein the probe antennas are configured to concurrently transmit the intermediate downlink signals and receive the uplink intermediate signals.

4. The system of claim 2, wherein the UL channel emulator is configured to generate the uplink output signals according to a specified set of impulse responses that relate the uplink output signals to the uplink intermediate signals, wherein each of the impulse responses has a programmable power profile and a programmable delay profile.

5. The system of claim 2, further comprising:
a plurality of duplexers, wherein each of the duplexers is coupled to a corresponding one of the probe antennas, to a corresponding output of the DL channel emulator and to a corresponding input of the UL channel emulator.

6. The system of claim 1, further comprising:
a link antenna positioned within the reverberation chamber to receive an uplink signal transmitted by the wireless device;
a cable configured to provide the uplink signal from the link antenna to a receive port of a base station or access point.

7. The system of claim 1, further comprising:
a link antenna positioned within the reverberation chamber to receive an uplink transmit signal transmitted by the wireless device;
an uplink channel emulator configured to generate uplink terminal signals based on the uplink transmit signal, wherein the uplink channel emulator is configured to output the uplink terminal signals at respective output ports.

8. The system of claim 1, wherein the probe antennas are located at positions at or near an interior wall of the RC.

9. The system of claim 1, wherein the number of downlink intermediate signals is greater than the number of the downlink stimulus signals.

10. The system of claim 1, wherein the DL channel emulator is configured to generate the downlink intermediate signals according to a specified set of impulse responses that relate the downlink intermediate signals to the downlink stimulus signals, wherein each of the impulse responses has a programmable power profile and a programmable delay profile.

11. The system of claim 10, wherein the specified set of impulses responses are determined by a wireless communication standard.

12. The system of claim 10, wherein the specified set of impulses responses are determined by field measurements of a fading signal environment.

13. A method for testing a wireless device, the method comprising:
receiving downlink stimulus signals;
generating downlink intermediate signals based on the downlink stimulus signals in order to emulate desired downlink channel characteristics, wherein the downlink intermediate signals are generated using a downlink channel emulator;
transmitting the downlink intermediate signals into a reverberation chamber (RC) using a plurality of probe antennas, wherein the wireless device is positioned within the reverberation chamber.

14. The method of claim 13, further comprising:
receiving uplink intermediate signals from the RC using the probe antennas, wherein the uplink intermediate signals are received in response to transmission of uplink transmit signals by the wireless device;
generating uplink output signals based on the uplink intermediate signals in order to emulate desired uplink channel characteristics, wherein the uplink output signal are generated by an uplink channel emulator.

15. The method of claim 14, wherein said transmitting of the downlink intermediate signals and said receiving of the uplink intermediate signals are performed concurrently.

16. The method of claim 13, further comprising:
receiving an uplink signal transmitted by the wireless device, wherein the uplink signal is received using a link antenna positioned within the RC;
providing the uplink signal from the link antenna to a receive port of a base station or access point using an electrical conductor.

17. The method of claim 13, further comprising:
receiving an uplink transmit signal transmitted by the wireless device, wherein the uplink transmit signal is received using a link antenna positioned within the RC;
generating uplink terminal signals based on the uplink transmit signal, wherein the uplink terminal signals are generated using an uplink channel emulator.

18. A system for testing wireless devices, the system comprising:
a first reverberation chamber (RC) configured to house a first wireless device;
first probe antennas located within the first RC, wherein the first probe antennas are configured to respectively receive first input signals from the first RC in response to transmission by the first wireless device;
a second RC configured to house a second wireless device;
second probe antennas located within the second RC;
a first channel emulator coupled to the first probe antennas and the second probe antennas, wherein the first channel emulator is configured to generate first output signals based on the first input signals, and transmit the first output signals respectively into the second RC using the second probe antennas.

19. The system of claim 18, further comprising:
a second channel emulator coupled to the first probe antennas and the second probe antennas, wherein the second probe antennas are configured to respectively receive second input signals from the second reverberation chamber in response to transmission by the second wireless device, wherein the second channel emulator is configured generate second output signals based on the second input signals, and transmit the second output signals respectively into the first RC using the first probe antennas.

20. The system of claim 19, wherein the first and second channel emulators generate respectively the first output signals and the second output signals at least partially concurrently.

21. The system of claim 19, wherein the second channel emulator is configured to generate the second output signals according to a specified set of impulse responses that relate the second output signals to the second input signals, wherein each of the impulse responses has a programmable power profile and a programmable delay profile.

22. The system of claim 18, wherein the first channel emulator is configured to generate the first output signals according to a specified set of impulse responses that relate the first output signals to the first input signals, wherein each of the impulse responses has a programmable power profile and a programmable delay profile.

23. The system of claim 18, further comprising:
a first plurality of duplexers, wherein each of the duplexers of the first plurality is coupled to a corresponding one of the first probe antennas, to a corresponding input of the first channel emulator and to a corresponding output of the second channel emulator;
a second plurality of duplexers, wherein each of the duplexers of the second plurality is coupled to a corresponding one of the second probe antennas, to a corresponding input of the second channel emulator, and to a corresponding output of the first channel emulator.

24. A method for testing wireless devices, the method comprising:
receiving first input signals from a first reverberation chamber (RC) in response to transmission by a first wireless device located within the first RC, wherein the first input signals are received using first probe antennas located within the first RC;
generating first output signals based on the first input signals using a first channel emulator;
transmitting the first output signals into a second RC for reception by a second wireless device located within the second RC, wherein the first output signals are transmitted using second probe antennas located within the second RC.

25. The method of claim 23, further comprising:
receiving second input signals from the second RC in response to transmission by the second wireless device, wherein the second input signals are received using the second probe antennas;
generating second output signals based on the second input signals using a second channel emulator;
transmitting the second output signals into the first RC for reception by the first wireless device, wherein the second output signals are transmitted using the first probe antennas.

26. The method of claim 24, wherein said transmitting the first output signals and said transmitting the second output signals are performed at least partially concurrently.

27. The method of claim 24, wherein the first output signals are generated according to a specified set of impulse responses that relate the first output signals to the first input signals, wherein each of the impulse responses has a programmable power profile and a programmable delay profile.

28. The method of claim 18, wherein the second output signals are generated according to a specified set of impulse responses that relate the second output signals to the second input signals, wherein each of the impulse responses has a programmable power profile and a programmable delay profile.
